(19) United States
(12) Patent Application Publication
(10) Pub. No.: US 2009/0058864 A1
(43) Pub. Date: Mar. 5, 2009

(54) METHOD AND SYSTEM FOR GRAPHICS PROCESSING

(75) Inventors: Cheng-Che Chen, Taipei County (TW); Yen-Yu Lin, Hsinchu County (TW); Shu-Wen Teng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/845,854

(22) Filed: Aug. 28, 2007

(51) Int. Cl. G09G 5/36; G06F 13/14; G09G 5/00

(52) U.S. Cl. 345/520; 345/204

(57) ABSTRACT

A graphics processing system is provided. The graphics processing system comprises a display unit, a frame buffer, an interface, and a controller. The frame buffer, defined by an initial pointer and a boundary pointer first image data in the frame buffer, stores first image data corresponding to a first image area displayed on the display unit. The interface receives a scrolling request directing the first image to scroll in a vertical and/or horizontal direction. The controller determines a reading pointer of the frame buffer according to the initial and boundary pointers and the scrolling request, loads new image data into a memory location at which a particular part of the first image data is stored. The new image data is loaded in a memory location in which an image area not included in the first image area after the scrolling is stored, retrieves the remaining first image data and the new image data beginning from the reading pointer, and directs the display unit to display the retrieved image data in sequence on a viewable image area thereof.

### BACKGROUND

The invention relates to image processing, and in particular to methods and systems for image display.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Some handheld devices are capable of processing and displaying an image. A handheld device with constrained computing and storage capabilities, offers diminished image processing speed and displayed image quality.

To present images on a display unit, conventionally, image data are read from a suitable storage medium, such as a CD-ROM, a hard disk, a server, or the like, and the retrieved image data are then stored in a buffer memory. A graphics processor accesses the image data stored in the buffer memory and moves the retrieved image data to a frame buffer. A display controller accesses the image data stored in the frame buffer in order correspondingly to continually refresh the content of the display unit.

According to a conventional method, a large frame buffer is required, wherein image data stored in the frame buffer corresponds to an image area larger than a display area in a display unit. FIGS. 1A and 1B illustrate image content corresponding to image data stored in a frame buffer; and FIGS. 1C and 1D illustrate image content presented on the display unit. Referring to FIG. 1A, image data corresponding to an image area 10 are stored in a frame buffer, and parts of the image area 10 are defined as a region of interest (ROI) 11a. Here, the size of the ROI 11a is the same as a display area, and the image content 13a of the ROI 11a is presented in the display area (shown in FIG. 1C). When the image content presented in the display area is scrolled in the vertical direction (for example, the image is scrolled downward), the region of interest is re-defined according to the scrolling operation, as shown in the ROI 11b of FIG. 1B. Correspondingly, the image content 13a presented in the display area is scrolled by Y pixels in the vertical direction. Here, the size of the ROI 11b is the same as the display area, and the image content 13b of the ROI 11b is presented in the display area (shown in FIG. 1D).

In the conventional method, it is necessary to have a large frame buffer for image data movement. In addition, the method is suitable only for static images, not for content generated in real-time.

Thus, a solution for scrolling an image without memory movement is desirable.

### SUMMARY

Certain aspects commensurate in scope with the originally claimed invention are set forth below. It should be understood that these aspects are presented merely to provide the reader as a brief summary of certain forms the invention might take and that these aspects are not intended to limit the scope of the invention. Indeed, the invention may encompass a variety of aspects that may not be set forth below.

A method for scrolling an image to be presented on a display unit is provided. A frame buffer is provided. The frame buffer is defined by an initial pointer and a boundary pointer. First image data is stored in the frame buffer. The first image data corresponds to a first image area displayed on the display unit. A scrolling request, is received, directing the first image to scroll in a vertical direction, horizontal direction, or both. A reading pointer of the frame buffer is determined according to the initial and boundary pointers and the scrolling request. New image data is loaded into a memory location at which a particular part of the first image data is stored. The new image data is loaded in a memory location in which an image area, not included in the first image area after scrolling, is stored. The remaining first image data and the new image data are retrieved beginning from the reading pointer, and if the retrieving operation reaches a boundary at which the boundary pointer is located, the retrieving operation resumes from an initial line at which the initial pointer is located. The retrieved image data is displayed on a viewable image area of the display unit.

A graphics processing system is provided. The graphics processing system comprises a display unit, a frame buffer, an interface, and a controller. The frame buffer, defined by an initial pointer and a boundary pointer to first image data in the frame buffer, stores first image data corresponding to a first image area displayed on the display unit. The interface receives a scrolling request directing the first image to scroll in a vertical and/or horizontal direction. The controller determines a reading pointer of the frame buffer according to the initial and boundary pointers and the scrolling request. New image data is loaded into a memory location at which a particular part of the first image data is stored. The new image data is loaded in a memory location in which an image area not included in the first image area after the scrolling is stored. The controller retrieves the remaining first image data and the new image data beginning from the reading pointer, and if the retrieving operation reaches a boundary at which the boundary pointer is located, the retrieving operation resumes from an initial line at which the initial pointer is located, directs the display unit to display the retrieved image data in sequence on a viewable image area thereof.

A graphics processing system is also provided. A physical memory stores image data corresponding to an image area. The image data is addressed by a physical address corresponding to a storage position of the image data within the physical memory. A controller converts a logical memory address to a physical address related to the image data. The logical address corresponds to a displayed position of an image corresponding to the image data. A controller retrieves the image data, according to an order defined by the logical address, from the physical memory according to the physical address. A display unit displays, according to the order defined by the logical address, the image content corresponding to the image data.

### BRIEF DESCRIPTION OF DRAWINGS

The invention can be more fully understood by reading the subsequent detailed description and examples with references made to the accompanying drawings, wherein:

FIGS. 1A˜1D illustrate a schematic view of image scrolling mechanism of a conventional graphics processing mechanism;

FIG. 2 is a schematic view of an embodiment of graphics processing system;

FIG. 3 is a flowchart of an embodiment of an image scrolling operation implemented by the processor of FIG. 2;

FIGS. 4A˜4D illustrate image data and corresponding image content before and after a scrolling operation in a vertical direction;

FIGS. 5A˜5D illustrate image data and corresponding image content before and after a scrolling operation in a horizontal direction;

FIGS. 6A˜6D illustrate image data and corresponding image content before and after a scrolling operation in both vertical and horizontal directions;

FIG. 7 is a schematic view of a second embodiment of graphics processing system;

FIG. 8 is a flowchart of an embodiment of a scrolling operation implemented by the graphics processing system 70 of FIG. 7; and

FIGS. 9A˜9C illustrate physical memory and logical memory before and after a scrolling operation in both vertical and horizontal directions.

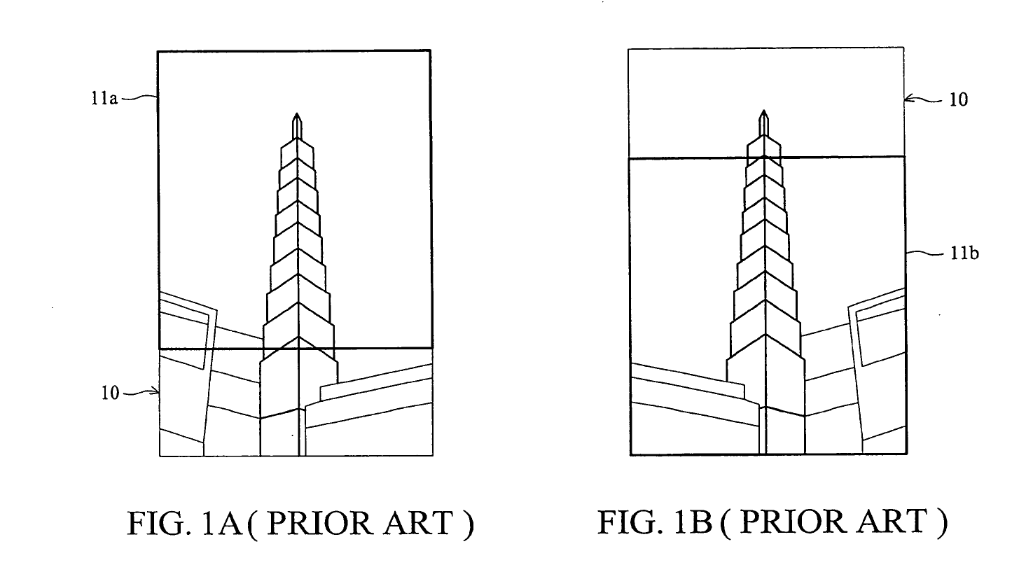

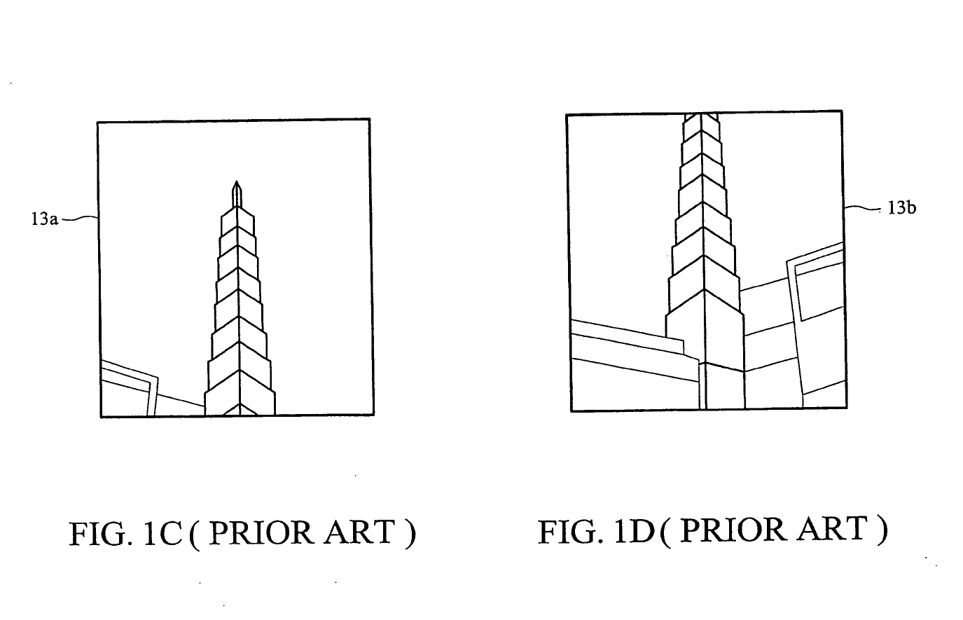

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings, which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component, which appears in multiple figures. It should be understood that the many of the elements described and illustrated throughout the specification are functional in nature and may be embodied in one or more physical entities or may take other forms beyond those described or depicted.

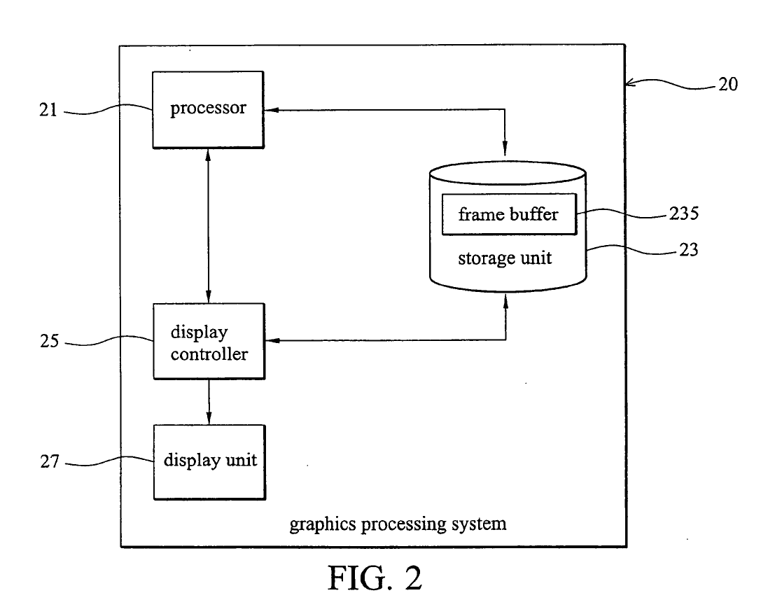

FIG. 2 is a schematic view of a first embodiment of graphics processing system. A graphics processing system 20 comprises a processor 21, a storage unit 23, a display controller 25, and a display unit 27. The storage unit 23 comprises a frame buffer 235.

To present images on the display unit 27, the processor 21 retrieves image data from a suitable storage medium, such as the storage unit 23, a server, or the like, and then stores the retrieved image data in the frame buffer 235. The processor 21 addresses the frame buffer 235, thus the image data stored in the frame buffer 235 of a specific area can be read and fed into the display unit 27. The operation implemented by the processor 21 may be software-based. The display controller 25 accesses the image data stored in the frame buffer 235 according to command issued by the processor 21 to refresh image content presented on the display unit 27.

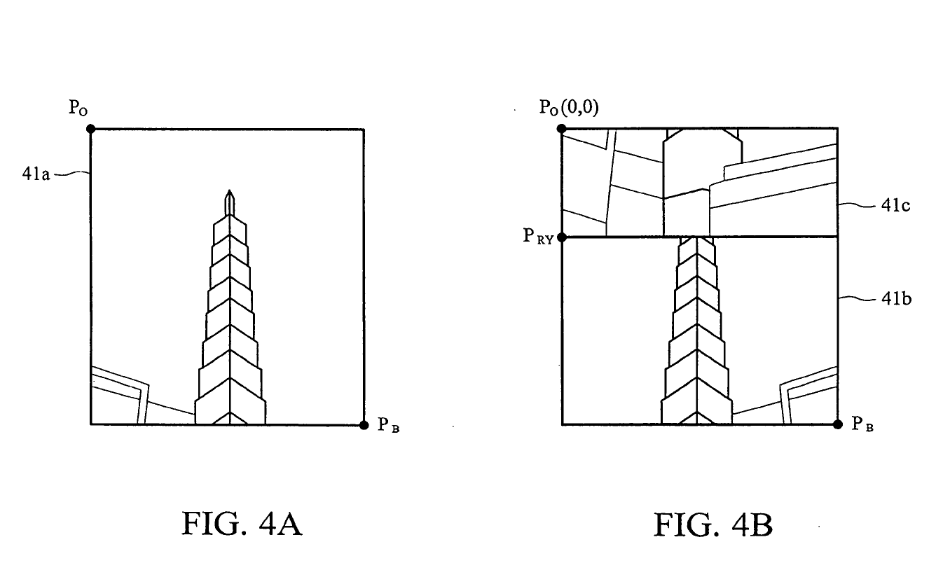

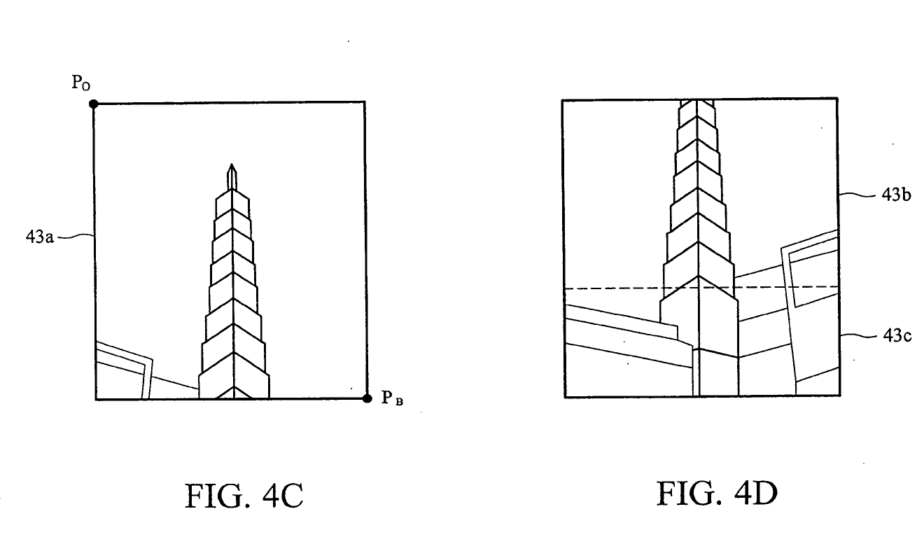

The frame buffer 235 is addressed with the aid of 2 pointers, i.e., an initial pointer P₀ and a boundary pointer P_{B} shown in FIGS. 4A and 4B. The initial pointer P₀ specifies a position of top-left corner of an image area within the frame buffer. The position is specified in the form of a specific pixel location. Similarly, the boundary pointer P_{B} specifies a position of a bottom-right corner of the image area of the frame buffer. The position is specified in the form of a specific pixel location. Information pertaining to the pointers can be stored in the storage unit 23 or in the display controller 25. In addition, the memory area of the frame buffer 235 can be dimensioned in such a way that it can store the image data of an image area which is equal to the area in which images can be presented on the display unit 27. Thus, by using the initial and boundary pointers and a reading pointer, when the image content presented on the display unit 27 is scrolled, the scrolling operation can be completed without memory movement. The scrolling operation of the processor 21 and utilization of the pointers are explained in greater detail in the following.

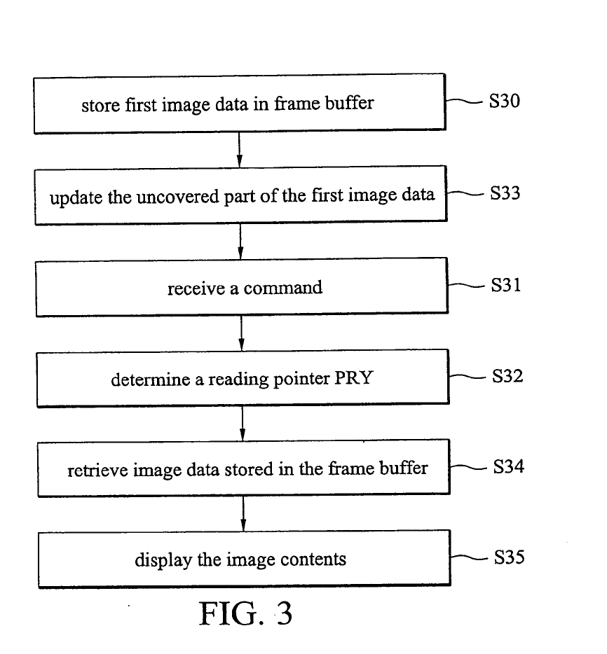

FIG. 3 is a flowchart of an embodiment of a scrolling operation implemented by the graphics processing system 20 of FIG. 2. FIGS. 4A and 4B illustrate image content corresponding to image data stored in a frame buffer before and after a scrolling operation in a vertical direction downward, respectively. FIGS. 4C and 4D illustrate image content presented on the display unit before and after a scrolling operation in a vertical direction upward, respectively.

In step S30, first image data is stored in the frame buffer 235. The frame buffer 235 is defined by an initial pointer P₀(0,0) and a boundary pointer P_{B}(x,y), wherein x is the width of the image area corresponding to the first image data stored in the frame buffer 235, y is the height of the image area corresponding to the first image data stored in the frame buffer 235. Referring to FIG. 4A, the first image data corresponding to image area 41a is stored in the frame buffer 235. The image content corresponding to image area 41a is presented on the display unit.

In step S31, a command is received, directing the image content presented in the display to scroll in a vertical direction (for example, the image is scrolled downward vertically).

In step S32, a reading pointer P_{RY} is determined according to the command received in step S31. For example, while the image content is to be scrolled downward by Y pixels, the position of the reading pointer P_{RY} is (0,Y), accordingly.

In step S33, the uncovered part of the first image data is updated by processor. Referring to FIG. 4B, after scrolling, the uncovered part is (0,0)-(x,Y), and this image area is updated by processor.

In step S34, image data stored in the frame buffer is retrieved and fed to the display unit 27 according to the initial pointer P₀, the boundary pointer P_{B}, and the reading pointer P_{RY}. For example, the reading pointer P_{RY} serves as a starting point for retrieving image data, and when the retrieved image area abuts the boundary pointer, i.e., the image data of image area 41b has been fed to the display unit, the retrieving operation resumes from the initial pointer P₀ to feed the image data of image area 41c to the display unit 27.

In step S35, the image content corresponding to image areas 41b and 41c are presented in the display unit in order, as shown in FIG. 4D.

According to the method of FIG. 3, a frame buffer has capacity adequate for storing image data corresponding to the viewable image area, and only image data not shown on the display unit after the scrolling operation is replaced by the newly presented image data displayed after the scrolling operation. In addition, the method is suitable for static images, as well as content generated in real-time.

In the described method, the scrolling operation in a vertical direction is given as an example. The method can also be implemented in scrolling operation in a horizontal direction, as well as in an oblique direction.

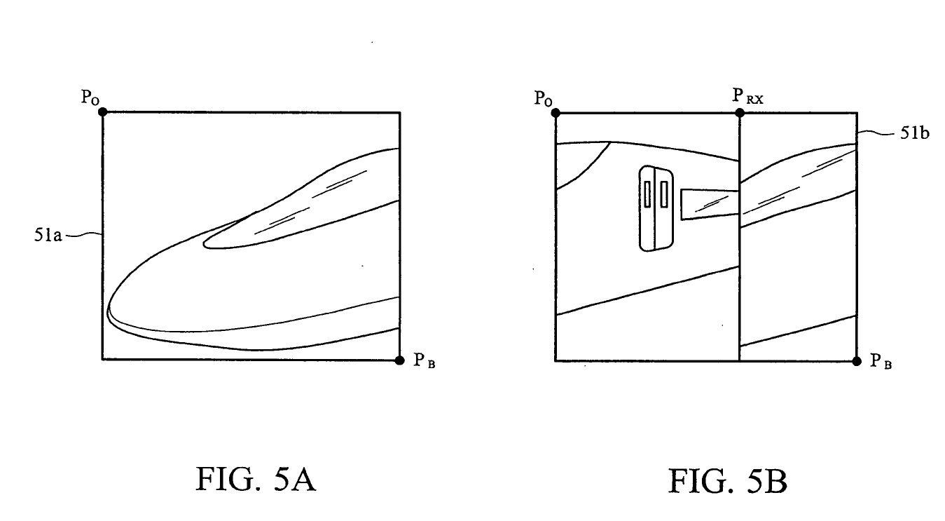

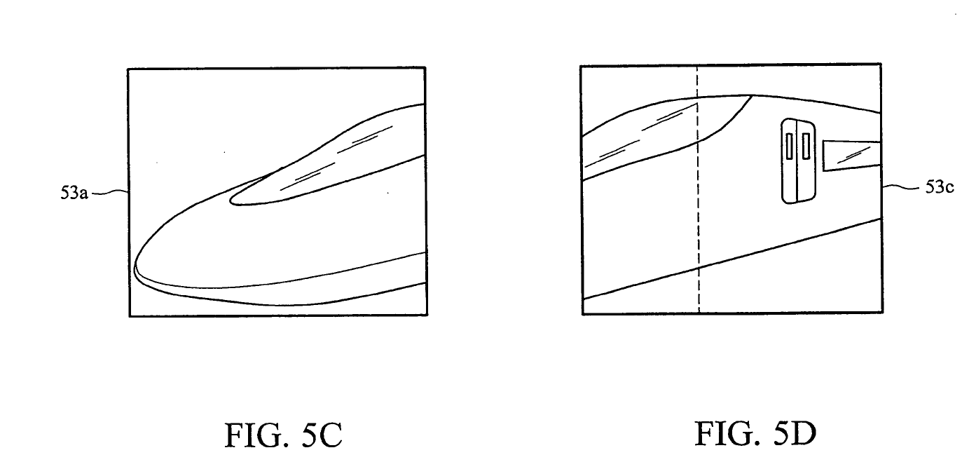

The method of FIG. 3 is described in the following with reference to a scrolling operation in a horizontal direction. FIGS. 5A and 5B illustrate image content corresponding to image data stored in a frame buffer before and after a scrolling operation in a left horizontal direction, respectively. FIGS. 5C and 5D illustrate image content presented on the display unit before and after a scrolling operation in a right horizontal direction, respectively.

In step S30, first image data is stored in the frame buffer 235. The frame buffer 235 is defined by an initial pointer P₀(0,0) and a boundary pointer P_{B}(x,y), wherein x is the width of the image area corresponding to the first image data stored in the frame buffer 235, y is the height of the image area corresponding to the first image data stored in the frame buffer 235. Referring to FIG. 5A, the first image data corresponding to image area 51a is stored in the frame buffer 235. The image content 53a corresponding to image area 51a is presented on the display unit, as shown in FIG. 5C.

In step S31, a command is received, directing the image content 53a presented in the display area to scroll in a horizontal direction (for example, the image is scrolled toward the left in the horizontal direction).

In step S32, a reading pointer P_{RX} is determined according to the command received in step S31. For example, if the image content 53a is to be scrolled to the right by X pixels, the position of the reading pointer P_{RX} is (X,0), accordingly.

In step S33, the uncovered part of the first image data is updated by processor. Referring to FIG. 5B, after scrolling, the uncovered part is (0,0)-(X, y), and this image area is updated by processor.

In step S34, image data stored in the frame buffer is retrieved and fed to the display unit 27 according to the initial pointer P₀, the boundary pointer P_{B}, and the reading pointer P_{RX}. For example, the reading pointer P_{RX} serves as a starting point for retrieving image data, and when the retrieved image area hits the vertical boundary x, the retrieving operation continues from horizontal position 0 until x pixels have been processed. The procedure is repeated row by row to feed the image data to the display unit 27.

In step S35, the image content 53b and 53c corresponding to image areas 51b and 51c are presented in the display unit in order, as shown in FIG. 5D.

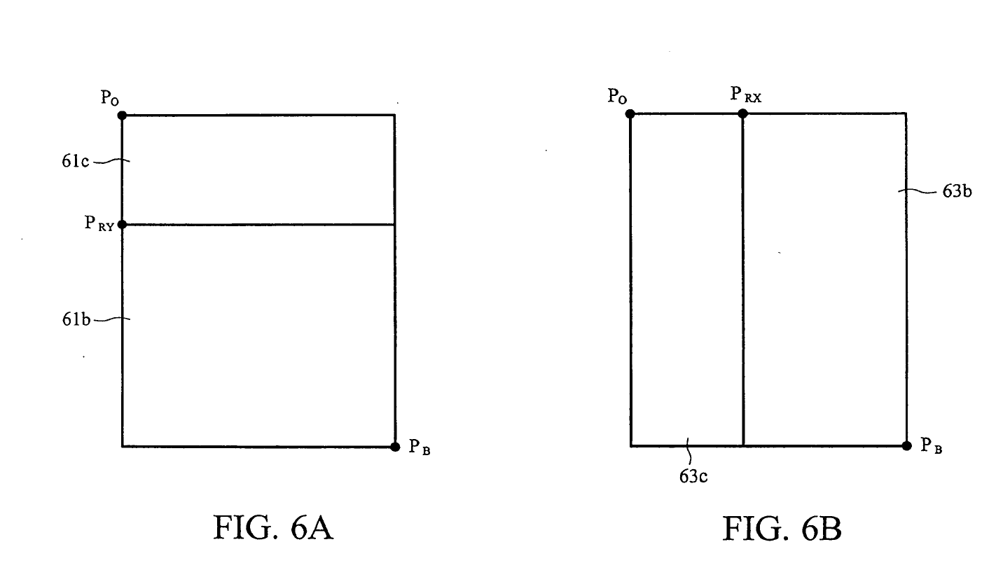

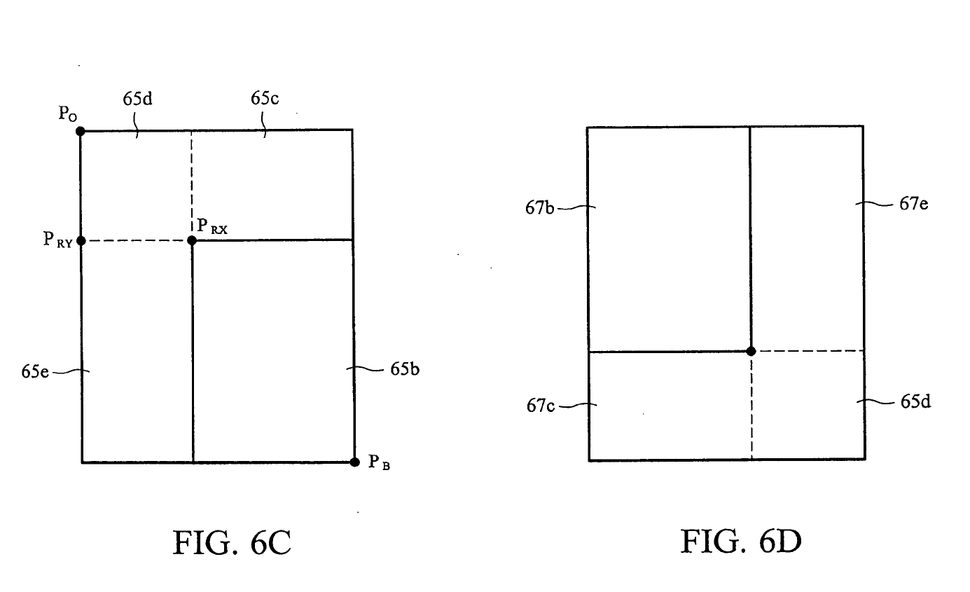

The method of FIG. 3 is explained below by executing a scrolling operation in an oblique direction, for example. The scrolling operation in an oblique direction can be implemented by combining the scrolling operation in a vertical direction and in a horizontal direction. For example, the image area is scrolled toward the lower-right corner thereof. In other words, the image area is scrolled downward in the vertical direction and toward the right in the horizontal direction. FIGS. 6A˜6D illustrate a schematic view of a scrolling operation in an oblique direction.

Again, in step S30, first image data (not shown) is stored in the frame buffer 235. The frame buffer 235 is defined by an initial pointer P₀(0,0) and a boundary pointer P_{B}(x,y), wherein x is the width of the image area corresponding to the first image data stored in the frame buffer 235, y is the height of the image area corresponding to the first image data stored in the frame buffer 235.

In step S31, a command is received, directing the image content presented in the display to scroll in an oblique direction (For example, the image area is scrolled toward the lower-right corner thereof).

In step S32, reading pointers P_{RY} and P_{Rx} are determined according to the command received in step S31 (as shown in FIGS. 6A and 6B).

Referring to FIG. 6A, when the image content is to be scrolled downward by Y pixels, the position of the reading pointer P_{RY} is (0,Y), accordingly. The reading pointer P_{RY} indicates that the update operation begins from the reading pointer P_{RY}. Referring to FIG. 6A, after the scrolling operation, image data corresponding to image area 61b is retained in the frame buffer; image data corresponding to the upper part of the original image area (not shown) is replaced by image data corresponding to image area 61c.

Referring to FIG. 6B, when the image content is to be scrolled toward the right by X pixel, the position of the reading pointer P_{RX} is (X,0), accordingly. The reading pointer P_{RX} indicates that the update operation begins from the reading pointer P_{RX}. Referring to FIG. 6B, after the scrolling operation, image data corresponding to image area 63b is retained in the frame buffer; image data corresponding to the left-hand column of the original image area (not shown) is replaced by image data corresponding to image area 63c.

In step S33, the image areas 65c, 65d, and 65e of the first image data are updated by processor.

In step S34, image data stored in the frame buffer is retrieved and fed to the display unit 27 according to the initial pointer P₀, the boundary pointer P_{B}, and the reading pointers P_{RX} and P_{RY}. For example, a reading pointer P_{RXY} having the X and Y coordinates of P_{RX} and P_{RY}, i.e., P_{RXY}(X,Y), serves as a starting point for retrieving image data.

In step S35, the image content corresponding to image areas 65b, 65e, 65c and 65d are presented in the display unit in order, as shown in FIG. 6D.

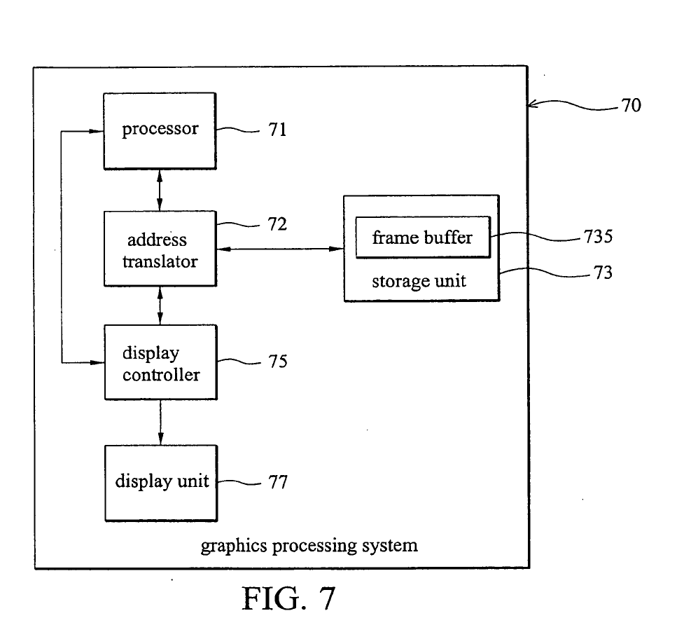

FIG. 7 is a schematic view of a second embodiment of graphics processing system. A graphics processing system 70 comprises a processor 71, an address translator 72, a storage unit 73, a display controller 75, and a display unit 77. The storage unit 73 comprises a frame buffer 735.

In order to present images on the display unit 77, the processor 71 retrieves image data from a suitable storage medium, such as the storage unit 73, a server, or the like and stores the retrieved image data in the frame buffer 735. The processor 71 through physical address information and logical address information addresses the frame buffer 735. Thus, the image data stored in the frame buffer 735 of a specific area can be read and fed to the display unit 77. The operation implemented by the processor 71 can be software-based. The display controller 75 accesses the image data stored in the frame buffer 235 according to the logical address information and corresponding physical address information determined by the processor 21 to refresh image content presented on the display unit 27.

The frame buffer 735 is addressed with the physical address information, and each of the pixels stored in the frame buffer 735 corresponds to the logical address information. For a particular pixel, the physical address information specifies a storage position of the pixel in the frame buffer 735 (a physical memory); the logical address information specifies a position of the pixel in a logical memory. Pixels are stored in the frame buffer 735 in a position specified by the physical address information, and are read from the frame buffer 735 and are displayed on a screen in the arrangement defined by the corresponding logical address information.

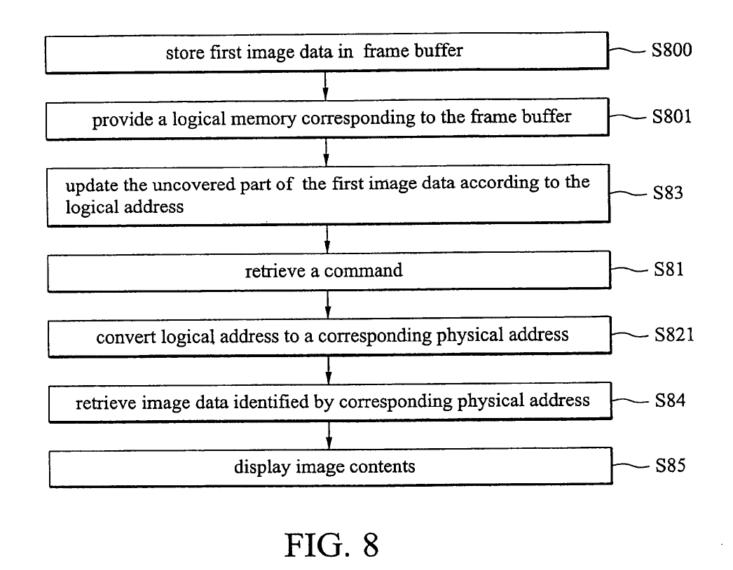

FIG. 8 is a flowchart of an embodiment of a scrolling operation implemented by the graphics processing system 70 of FIG. 7.

In step S800, first image data is stored in the frame buffer 735. The frame buffer 735 is specified as a physical memory, wherein each bit of data is identified by its storage position, i.e., physical address.

In step S801, a logical memory corresponding to the frame buffer 735 is provided. The logical memory specifies displayed image arrangement of the image data stored in the frame buffer.

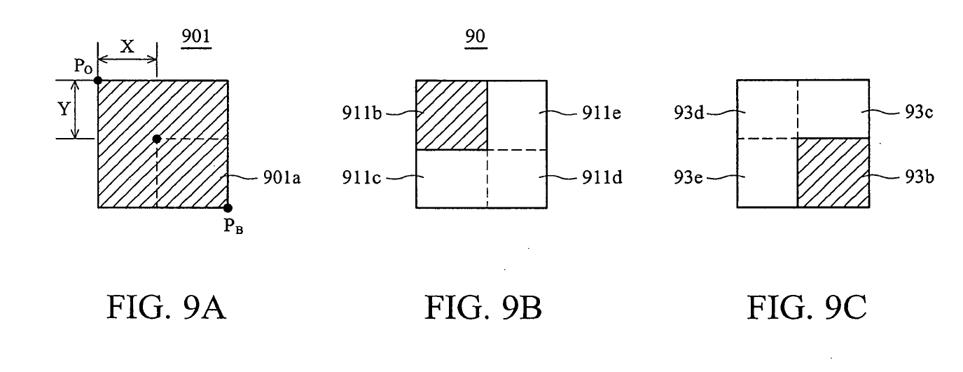

In step S81, a command is received, directing the image content presented in the display to scroll in an oblique direction (for example, the image area is scrolled toward the lower-right corner thereof). Here, the image content is to be scrolled downward by Y pixels, and scrolled toward the right by X pixels. Referring to FIG. 9A, the dashed line specifies a boundary of an image area displayed after the scrolling operation, wherein image data of image area 901 is to be updated, and image data of image area 901a remains after the scrolling operation.

In step S821, logical address of each bit of data in the logical memory is converted to a corresponding physical address. For example, physical address (PA) of data with logical address (LA) is determined as described in the following. Generally, the number of bytes per pixel for an image is 1, 2, 3, or 4. First, logical position (Lpos) of the data is determined as:

Lpos=logical address/(byte per pixel).

In addition, logical position in the y direction is:

Ly=Lpos/(width of image area).

In addition, logical position in the x direction is:

Lx=Lpos%(width of image area)

Accordingly, physical position in the y direction is:

Py=(Ly+Y)%(height of image area).

Physical position in the x direction is:

Px=(Lx+X)%(width of image area)

Accordingly, physical address corresponding to the logical address is:

PA=[Py*(width of image area)+Px]*(byte per pixel).

In step S83, the uncovered part of the first image data stored in the frame buffer 735 is updated. Referring to FIG. 9C, memory sections for image areas 93c, 93d, and 93e are loaded with image data from the data source.

In step S84, image data stored in the frame buffer 735 is retrieved from the storage position identified by corresponding physical address, and is fed to the display unit 27.

In step S85, the image content corresponding to image areas 93b, 93e, 93c and 93d are presented in the display unit according to the image arrangement defined by the logical memory.

Methods and systems of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for scrolling an image to be presented on a display unit, comprising:
providing a frame buffer defined by an initial pointer and a boundary pointer;
storing first image data in the frame buffer, wherein the first image data corresponds to a first image area displayed on the display unit;
loading new image data into a memory location at which a particular part of the first image data is stored, wherein the new image data is loaded in a memory location in which an image area not included in the first image area after the scrolling;
receiving a scrolling request, directing the first image to scroll in a vertical and/or horizontal direction;
determining a reading pointer of the frame buffer according to the initial and boundary pointers and the scrolling request;
retrieving the remaining first image data and the new image data beginning from the reading pointer, and if the retrieving operation reaches the image width, the retrieving operation continues from the first horizontal location for each row, and repeat the process for each column, and if the boundary pointer is hit, the retrieving operation resumes from an initial line at which the initial pointer is located; and
displaying, in a viewable image area of the display unit, the retrieved image data in sequence.

2. The method of claim 1, wherein the initial pointer corresponds to the top-left corner of the viewable image area of the display unit, and the boundary point corresponds to a bottom-right portion of the viewable image area of the display unit.

3. The method of claim 1, wherein the new image data corresponds to image content generated in real-time.

4. The method of claim 1, wherein the new image data corresponds to static image contents.

5. The method of claim 1, wherein the frame buffer stores image data corresponding to an image area having the same width and height as the viewable image of the display unit.

6. A method for displaying an image, comprising:
providing a physical memory storing image data corresponding to an image area, wherein the image data is addressed by a physical address corresponding to a storage position of the image data within the physical memory;
converting the logical address to the physical address;
retrieving the image data, according to an order defined by the logical address, from the physical memory according to the physical address; and
displaying, according to the order defined by the logical address, the image content corresponding to the image data on a display unit.

7. The method of claim 6, wherein the image data corresponds to image content generated in real-time.

8. The method of claim 6 wherein the image data corresponds to static image contents.

9. The method of claim 6, wherein the wherein the physical memory stores image data corresponding to an image area having the same width and height as a viewable image of the display unit.

10. The method of claim 9, further comprising:
providing information of byte per pixel of the image data (BPP), width of the image area (W), and height of the image area (H);
receiving a scrolling command, directing the image area to be scrolling X pixels in a vertical direction, and Y pixels;
converting the logical address (LA) to the physical address (PA) according to the following equation:
Lpos=logical address/(byte per pixel)
Ly=Lpos/(width of image area)
Lx=Lpos%(width of image area)
Py=(Ly+Y)%(height of image area)
Px=(Lx+X)%(width of image area)
PA=[Py*(width of image area)+Px]*(byte per pixel).

11. A graphics processing system, comprising:
a display unit;
a frame buffer, defined by an initial pointer and a boundary pointer first image data in the frame buffer, storing first image data corresponding to a first image area displayed on the display unit;
an interface receiving a scrolling request, directing the first image to scroll in a vertical and/or horizontal direction; and
a controller determining a reading pointer of the frame buffer according to the initial and boundary pointers and the scrolling request, retrieving the image data beginning from the reading pointer, and if the retrieving operation reaches the width of the image, continues from the first horizontal location for each row, and repeat the process for each column, and if the boundary pointer is hit, the retrieving operation resumes from an initial line at which the initial pointer is located, directing the display unit to display the retrieved image data in sequence on a viewable image area thereof.

12. The graphics processing system of claim 11, wherein the controller determines the initial pointer corresponding to the top-left corner of the viewable image area of the display unit, and the boundary point corresponding to a bottom-right of the viewable image area of the display unit.

13. The graphics processing system of claim 11, wherein the processor loads the new image data corresponding to image content generated in real-time.

14. The graphics processing system of claim 11, wherein the processor loads the new image data corresponding to static image contents.

15. The graphics processing system of claim 11, wherein the frame buffer stores image data corresponding to an image area having the same width and height with the viewable image of the display unit.

16. A graphics processing system, comprising:
a physical memory storing image data corresponding to an image area, wherein the image data is addressed by a physical address corresponding to a storage position of the image data within the physical memory;
a controller converting the logical address to the physical address, and retrieving the image data, according to an order defined by the logical address, from the physical memory according to the physical address; and
a display unit displaying, according to the order defined by the logical address, the image content corresponding to the image data.

17. The graphics processing system of claim 16, wherein the controller retrieves the image data corresponding to image content generated in real-time.

18. The graphics processing system of claim 16, wherein the controller retrieves image data corresponds to static image contents.

19. The graphics processing system of claim 16, wherein the physical memory stores image data corresponding to an image area having the same width and height as a viewable image of the display unit.

20. The graphics processing system of claim 19, wherein the controller further performs steps of:
providing information of byte per pixel of the image data (BPP), width of the image area (W), and height of the image area (H);
receiving a scrolling command, directing the image area to be scrolling X pixels in a vertical direction, and Y pixels;
converting the logical address (LA) to the physical address (PA) according to the following equation:
Lpos=logical address/(byte per pixel)
Ly=Lpos/(width of image area)
Lx=Lpos%(width of image area)
Py=(Ly+Y)%(height of image area)
Px=(Lx+X)%(width of image area)
PA=[Py*(width of image area)+Px]*(byte per pixel).
